(19) United States
(12) Patent Application Publication
(10) Pub. No.: US 2009/0236866 A1
(43) Pub. Date: Sep. 24, 2009

(54) BUMPER REINFORCEMENT FOR AN AUTOMOBILE

(76) Inventor: Hwa Sun Lee, Daejeon (KR)

Correspondence Address: AUSTIN RAPP & HARDMAN, 170 South Main Street, Suite 735, SALT LAKE CITY, UT, 84101, US

(21) Appl. No.: 12/375,373

(22) PCT Filed: Jul. 26, 2007
(86) PCT No.: PCT/KR07/03589

§ 371 Date: Jan. 27, 2009

(30) Foreign Application Priority Data
Jul. 27, 2006 (KR) 10-2006-0070916

(51) Int. Cl. B60R 19/18

(52) U.S. Cl. 293/132; 293/155

(57) ABSTRACT

The present invention relates to a bumper reinforcement for an automobile, which is formed with at least two or more closed sectional surfaces at connection parts which are positioned between an impact part and tower parts, for absorbing impact energy upon collision and preventing breakage of the bumper reinforcement.

### TECHNICAL FIELD

The present invention relates to a bumper reinforcement for an automobile, and more particularly to, a bumper reinforcement for an automobile, in which at least two or more closed sectional surfaces are formed in connection parts, which is formed between an impact part and tower parts, for absorbing impact energy and preventing breakage of the bumper reinforcement when impact is applied to the bumper reinforcement, thereby reinforcing the bumper reinforcement for an automobile further.

### BACKGROUND ART

FIG. 1 is an exploded perspective view showing a bumper reinforcement 10 coupled with a bumper 1 for a vehicle. As shown in FIG. 1, the bumper reinforcement 10 is fixed in the bumper 1, which is respectively mounted at front and rear parts of a body frame of a vehicle, so that the bumper reinforcement absorbs impact energy effectively and prevents passengers in the automobile from being wound when collision of the automobile happens while the automobile is running.

FIG. 2 is a partial sectional view showing a prior art bumper reinforcement for an automobile, which includes an impact part 12 having a vertical section in the shape of “□” along the shape of the bumper 1, and one or more tower parts 14 mounted at both end parts of the impact part 12 and having vertical side surfaces 16.

The tower parts 14 are mounted to the body frame (not shown) of a vehicle at a base plate, which serve to buffer the pressure and tension generated from the bumper upon collision and prevent the impact, the pressure and the tension from being transmitted to the body frame directly.

Therefore, most deformation is generated at inner surfaces of the tower parts, which are located at innermost positions, and the impact part, which are in contact with the inner surfaces of the tower parts.

In the bumper having the tower parts 14 formed with the vertical side surfaces as above, the tower parts and the reinforcement structure become seriously deformed due to the force transmitted to the part “A” of FIG. 3. In this case, since the deformation is permanent, even for a weak collision, the entire bumper should be replaced with a new one.

In order to resolve the above problems, in improved bumper reinforcement for an automobile has been suggested in Korean Patent No. 0340464, wherein coupling parts between a body part and tower parts in the bumper reinforcement are formed inclinedly for minimizing deformation upon collision and simultaneously reducing permanent deformation, thereby extending the lifespan of the bumper.

in the bumper having the slant coupling parts between the body part and the tower parts, a slant surface 20 supports breakage of an upper plate 18 and a lower plate 19, so that connection parts became strengthened and more resistant against impact, as shown in FIG. 5.

The prior art bumper reinforcement has, however, a problem that deformation cannot be sufficiently absorbed by the reinforced connection parts, so that a part C of the body part becomes broken by an impact over a predetermined degree, and collision energy absorbed by the bumper is not high.

Further, the prior art bumper has further problems that ends of the upper plate and the lower plate press a bumper cover upon collision so that the bumper cover is apt to be damaged, and the upper plate and the lower plate in linear contact with the bumper cover are bent at ends so that the bumper reinforcement becomes damaged partially.

### DISCLOSURE OF INVENTION

### Technical Problem

Therefore, the present invention is derived to resolve the above and any other disadvantages of the prior art.

According to the present invention, there is an object to provide a bumper reinforcement for an automobile, in which connection parts formed between an impact part and tower parts are formed with at least two or more closed sectional surfaces for absorbing impact energy effectively and preventing breakage of the bumper reinforcement.

According to the present invention, there is another object to provide a bumper reinforcement for an automobile for increasing final tolerable strength for bearing a large impact.

### Technical Solution

In order to achieve the foregoing objects, the present invention provides a bumper reinforcement for an automobile including an impact part positioned at a front part of a body frame of an automobile,

tower parts formed at both right and left side ends of the impact part and fixed to the body frame,

connection parts for connecting the impact part to the tower parts, and

a reinforcement plate having at least two or more upper closed sectional surface and lower closed sectional surface respectively mounted divisionally.

the bumper reinforcement for an automobile according to the present invention

Therefore, the formation of the at least two or more closed sectional surfaces increases the section modulus, which remarkably increases absorbability of large impact transmitted from the center part by a head-on collision or a rear-end collision.

### Advantageous Effects

As described hereinabove, according to the present invention, the reinforcement plate forms the closed sectional surfaces at spaces of the connection parts so as to improve allowable impact absorbability.

Therefore, even the large impact energy is effectively absorbed in the closed sectional surfaces and simultaneously a moderate ratio of deformation may be kept.

Further, the bumper reinforcement for an automobile according to the present invention may be commonly used for front parts of bumpers of 2.5 miles or 5 miles. Furthermore, the allowable impact absorbability is high enough to satisfy bumper-relating regulations.

In the meantime, a center portion of a back beam is hardly bent by impact so that the resistance against impact is relatively uniform and sensor operation for air bags becomes advantageous.

The collision performance of the body frame of the automobile may be increased by additionally mounting further parts in an empty space around a stay mount, and a weight of the entire bumper may be reduced.

### BRIEF DESCRIPTION OF THE DRAWINGS

The objects, features and advantages of the present invention will be more clearly understood from the following detailed description in conjunction with the accompanying drawings, in which:

FIG. 1 is an exploded perspective view showing a prior art bumper for an automobile;

FIG. 2 is a sectional view showing a prior art bumper reinforcement for an automobile;

FIG. 3 is a perspective view showing the prior art bumper reinforcement for an automobile;

FIG. 4 is a perspective view showing another prior art bumper reinforcement for an automobile;

FIG. 5 is a sectional view taken along the line A-A′ of FIG. 4;

FIG. 6 to FIG. 15 are views respectively showing different bumper reinforcements for an automobile according to preferred embodiments of the present invention, wherein FIG. 6, FIG. 8, FIG. 10, FIG. 12 and FIG. 14 show exploded perspective views showing coupling states of reinforcement plates by cutting the bumper reinforcements by half approximately, and FIG. 7, FIG. 9, FIG. 11, FIG. 13 and FIG. 15 are sectional views showing the bumper reinforcements cut at connection parts;

FIG. 16 is a graph showing a breakage curve of the prior art bumper reinforcement for an automobile, which is not formed with closed sectional surfaces; and

FIG. 17 is a graph showing a breakage curve of a bumper reinforcement for an automobile according to the present invention, in which closed sectional surfaces are formed at connection parts.

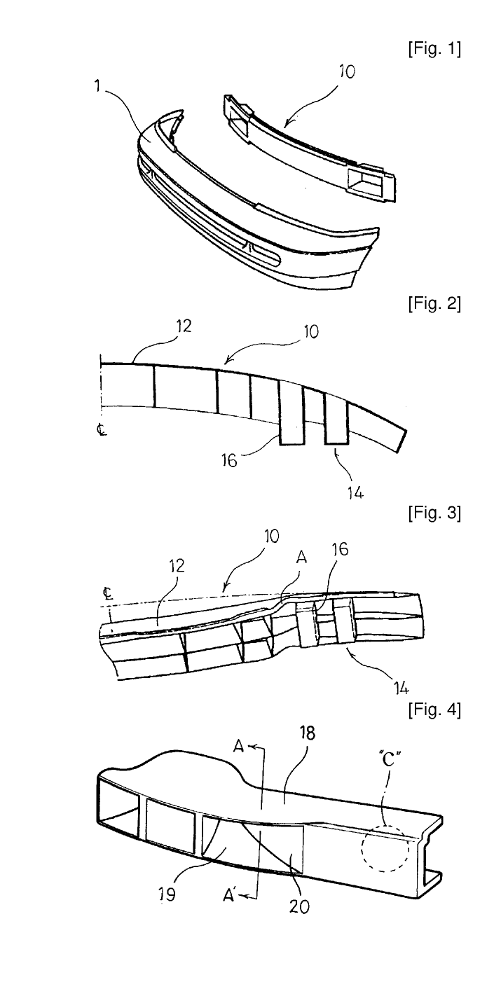

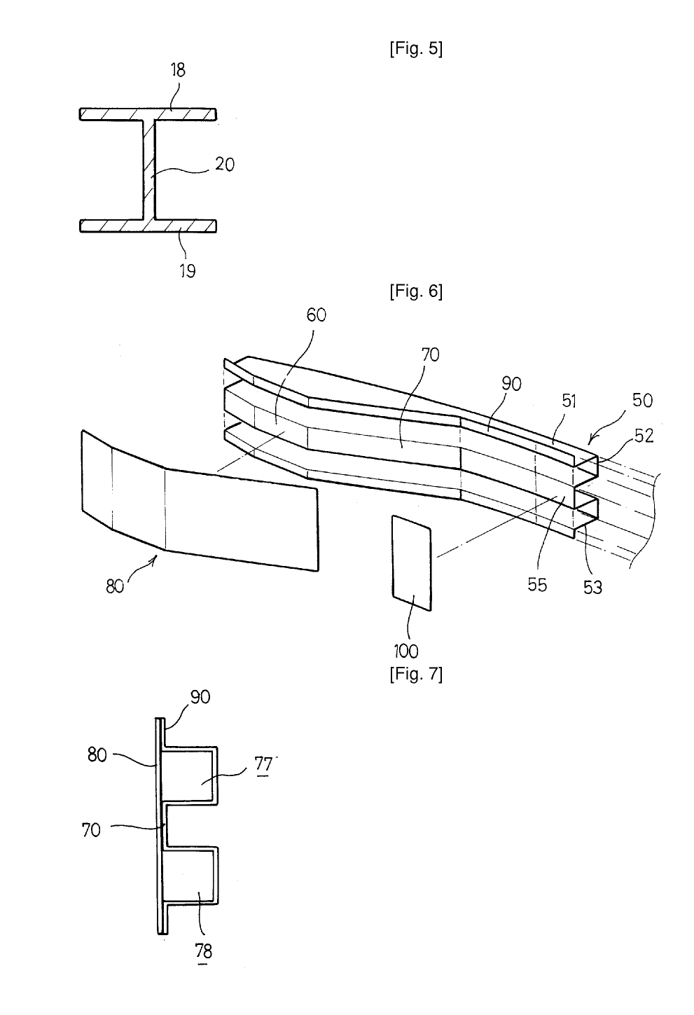

### MODE FOR THE INVENTION

Now, a bumper reinforcement for an automobile according to the present invention will be described in more detail in the structure and operation thereof with reference to the accompanied drawings. The present invention is not limited thereto and the preferred embodiments are simply disclosed as examples.

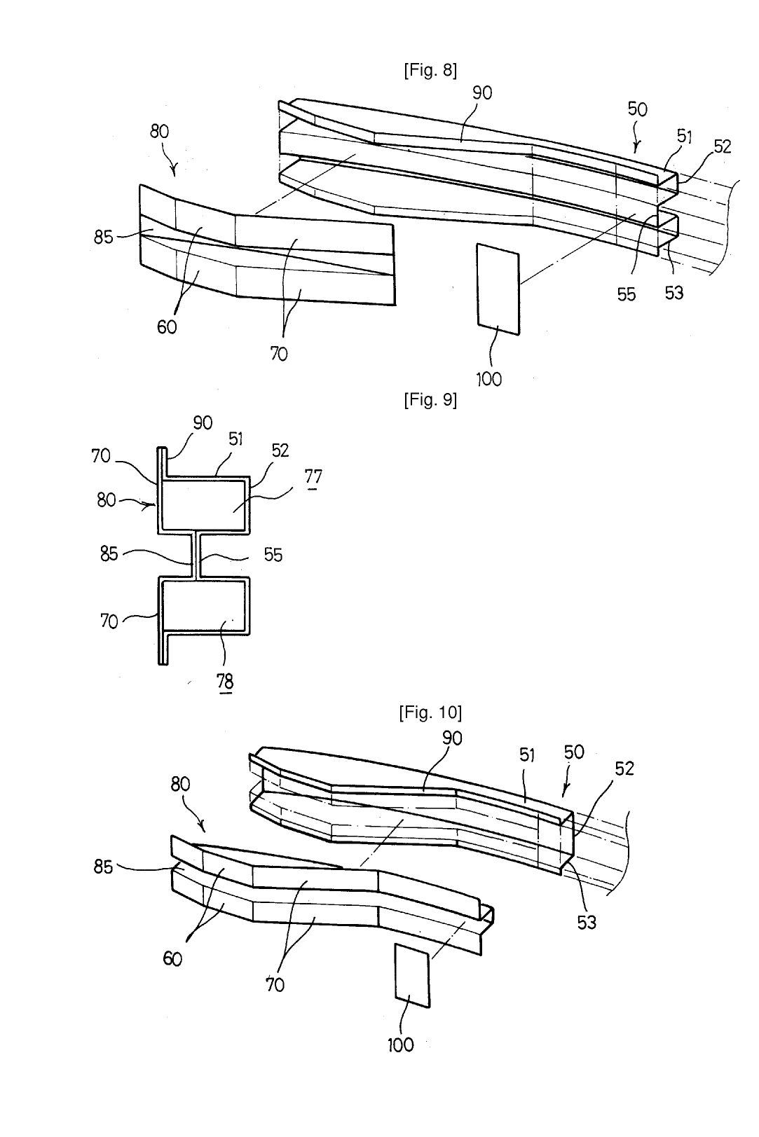

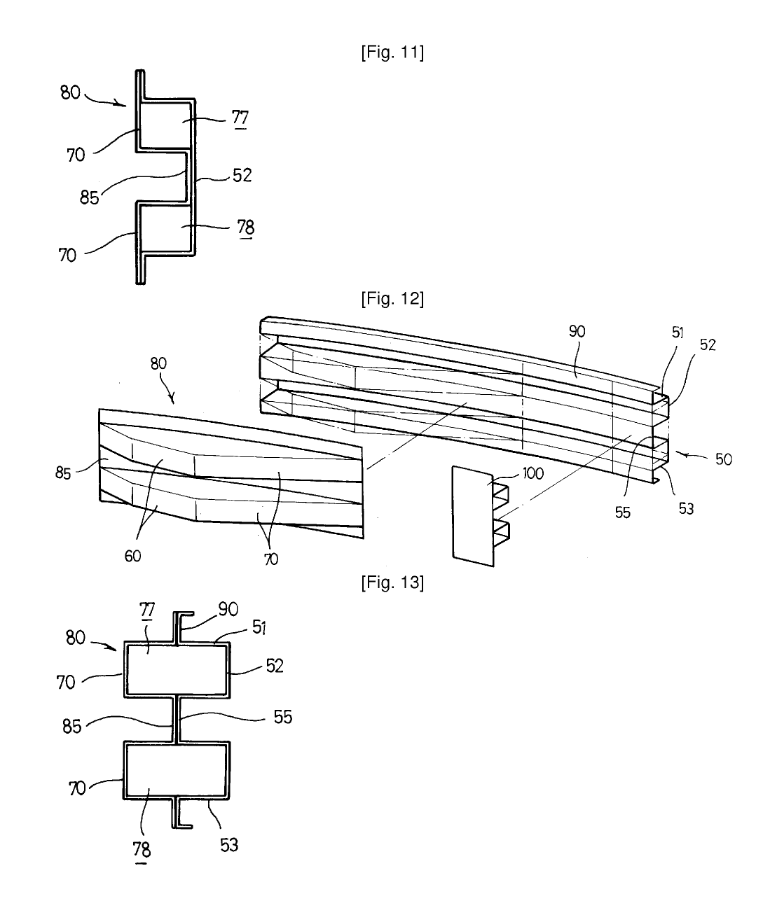

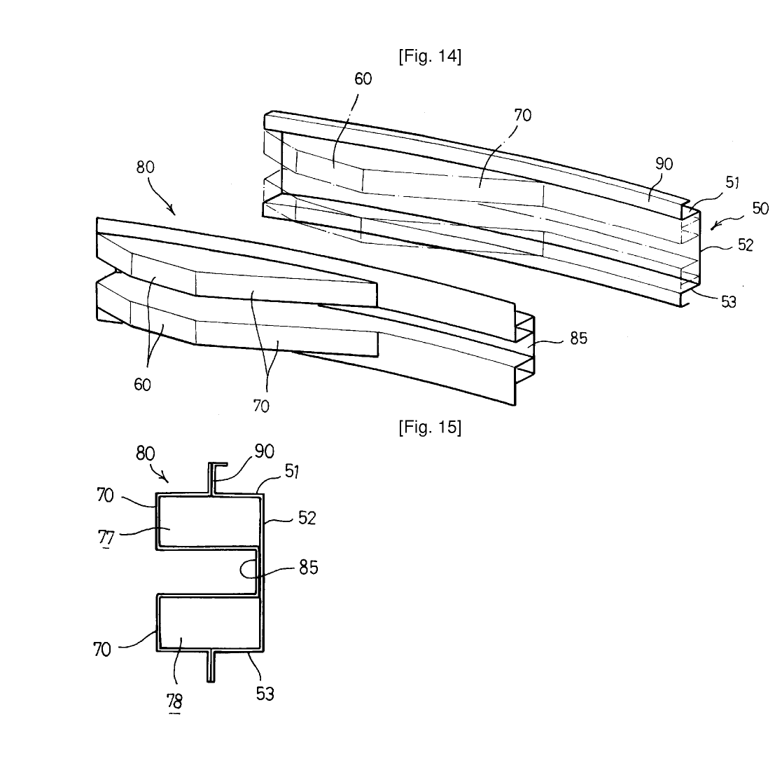

FIG. 6 to FIG. 15 are views respectively showing different bumper reinforcements for an automobile according to preferred embodiments of the present invention, wherein FIG. 6, FIG. 8, FIG. 10, FIG. 12 and FIG. 14 show disassembled perspective view showing coupling states of reinforcement plates by cutting the bumper reinforcements by half approximately, and FIG. 7, FIG. 9, FIG. 11, FIG. 13 and FIG. 15 are sectional views of the bumper reinforcements.

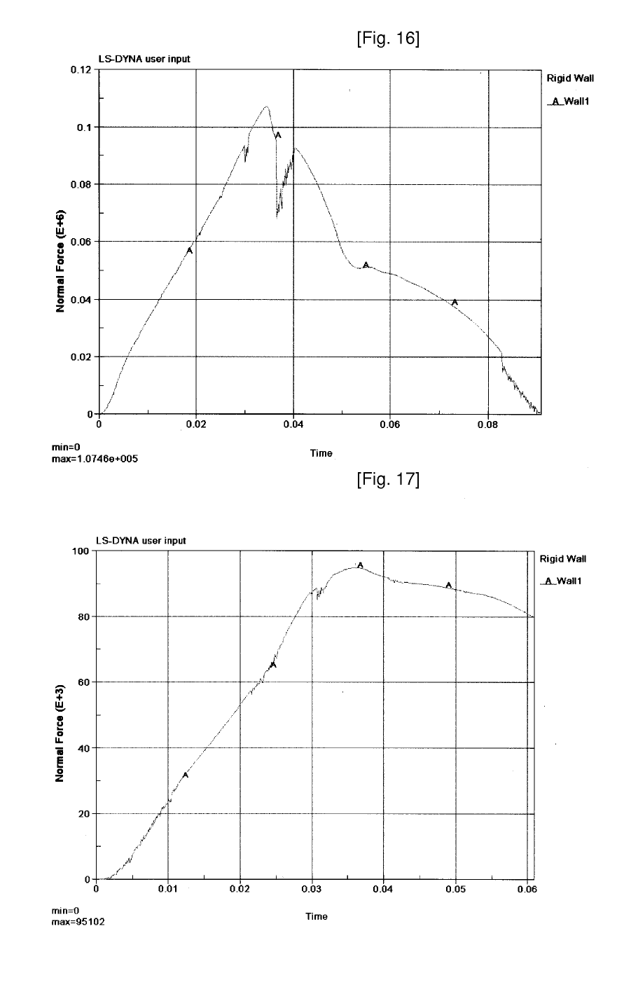

FIG. 16 is a graph showing a breakage curve of the prior art bumper reinforcement, which is not formed with closed sectional surfaces; and

FIG. 17 is a graph showing a breakage curve of the bumper reinforcement according to the present invention, in which closed sectional surfaces are formed at connection parts.

As shown in FIG. 6 to FIG. 15, a bumper reinforcement for an automobile according to the present invention includes an impact part 50, tower parts 60 and connection parts 70 for connecting the impact part 50 to the tower parts 60.

The impact part 50 is positioned in the middle of the tower parts 60, wherein contact deformation is substantially generated in the impact part 50 upon a head-on collision. The impact part 50 has an upper plate 51 and a lower plate 53 which are formed in the horizontal direction with respect to the ground and covered by a front plate 52 at front portions thereof.

Therefore, the upper plate 51 of the impact part 50 is formed at an upper part the bumper reinforcement 100 (upper side of FIG. 6 to FIG. 15) and the front plate 52 is mounted to the upper plate 51 perpendicularly to cover the upper plate 51, wherein the front plate 52 is formed in the vertical direction with respect to the ground. The lower plate 53 is coupled with a lower end of the front plate 52 at an end.

The tower parts 60 are formed at both sides of the impact part 50 symmetrically even though one of the tower parts 60 is represented in the accompanied drawings.

The tower part 60 are mounted at both sides of a front part of a body frame of an automobile.

When the automobile collides with another automobile which is positioned in front thereof during running, the impact part 50 positioned in the center contacts the opposite automobile and becomes withdrawn, wherein deformation of the impact part 50 is absorbed by the connection parts 70.

Therefore, reinforcement of the connection parts 70 is very important.

According to the present invention, the connection parts 70 are formed with at least two or more closed sectional surfaces for increasing section modulus to improve strength.

FIG. 6 and FIG. 7 show a bumper reinforcement for an automobile according to a preferred embodiment of the present invention.

Referring to FIG. 6 and FIG. 7, a bead groove 55 is formed from the central impact part 50 to the tower parts 60 through the connection parts 70 and entirely folded backward, and a flat reinforcement plate 80 is attached to rear surfaces of the connection parts 70.

The bead groove 55 formed in the connection parts 70 is connected to the tower parts 60 as being withdrawn backward with inclination.

The reinforcement plate 80 may be attached to the rear surfaces of the connection parts 70. If the reinforcement plate 80 is extended to the tower parts 60, the closed sectional surfaces are formed in the tower parts 60, thereby increasing reinforcement effect.

Referring to FIG. 7, the bead groove 55 is formed with a predetermined depth from sectional surfaces of the connection parts 70 for contacting the reinforcement plate 80, so that an upper closed sectional surface 77 and a lower closed sectional surface 78 are respectively formed by two divisionally.

Therefore, the connection parts 70 are reinforced by the reinforcement plate 80 and the upper closed sectional surface 77 and the lower closed sectional surface 7, which are separated from each other, increase section modulus, so that stress against impact becomes increased.

Attachment of the reinforcement plate 80 is carried out by spot welding while the reinforcement plate 80 is in contact with flange parts 90, as shown in FIG. 7.

Also, adhesive agent may be used for the attachment.

It is preferable to attach another plate 100 to a rear part of the central impact pact 50 for forming further two or more closed sectional surfaces at a distance from the connection parts 70 to reinforce the impact part 50.

Referring to FIG. 8 and FIG. 9, the bead groove 55 is rounded with a relatively large radius from the central impact part 50 to the tower parts 60 through the connection parts 70, and the reinforcement plate 80 formed in the complimentary shape with the flange parts 90 has a bead part 85 protruded by a depth for contacting the bead groove 55.

The reinforcement plate 80 may be attached to the rear parts of the connection parts 70. If the reinforcement plate 80 is extended to the tower parts 60, the closed sectional surfaces are formed in the tower parts, so that further strength reinforcement effect may be realized, as shown in FIG. 8 and FIG. 9.

Referring to FIG. 9, the bead groove 55 contacts the bead parts 85, which is protruded from the reinforcement plate 80, at the sectional surfaces of the connection parts 70, so that the upper closed surfaces 77 and the lower closed surfaces 78 are formed by two divisionally.

Therefore, the connection parts 70 are reinforced by the reinforcement plate 80 and the upper closed surfaces 77 and the lower closed surfaces 78 increase the section modulus, increasing the stress against impact.

It is preferable to attach another plate 100 to a rear part of the central impact pacts 50 for forming further two or more closed sectional surfaces at a distance from the connection parts 70 to reinforce the impact part 50.

Referring to FIG. 10 and FIG. 11, the central impact part 50, the connection parts 70 and the tower parts 60 are not formed with the bead groove 55 since a front plate 52 covers the impact part 50, the connection parts 70 and the tower parts 60. The reinforcement plate 80 is formed in the complementary shape with the flange parts 90 and has the bead part 85 protruded by the depth for contacting the front plate 52.

The reinforcement plate 80 may be attached to the rear parts of the connection parts 70. If the reinforcement plate 80 is extended to the impact part 50 and the tower parts 60, the closed sectional surfaces are formed in the impact part 50 and the tower parts 60, so that further strength reinforcement effect may be realized, as shown in FIG. 10 and FIG. 11.

Referring to FIG. 11, the front plate 52 contacts the bead parts 85, which is protruded from the reinforcement plate 80, at the sectional surfaces of the connection parts 70, so that the upper closed surfaces 77 and the lower closed surfaces 78 are formed by two divisionally.

Therefore, the connection parts 70 are strengthened by the reinforcement plate 80 and the upper closed surfaces 77 and the lower closed surfaces 78, which are separated from each other, increase the section modulus, increasing the stress against impact.

Referring to FIG. 12 and FIG. 13, the central impact part 50 is formed with flange parts 90 at upper and lower parts thereof and a bead groove 55 in the center. The impact part 50 having the flange parts 90 and the bead groove 55 is extended to the tower parts 60 through the same section by roll forming, and the connection parts 70 and the tower parts 60, of which rear parts are attached with the reinforcement plate 80, are formed with the bead part 85 in the complementary shape therewith.

The reinforcement plate 80 is extended from the connection parts 70, which are slantly withdrawn backward, to the tower parts 60, and two upper and lower bead parts 85 are protruded from rear surfaces thereof.

Referring to FIG. 13, the bead groove 55 contacts the reinforcement plate 80 at a cut section of the connection parts 70, and the upper closed sectional surfaces 77 and the lower closed sectional surfaces 78 are formed by two divisionally by the bead parts 85 formed at upper and lower parts of the reinforcement plate 80.

Therefore, the connection parts 70 has an increased section modulus by the upper closed surfaces 77 and the lower closed surfaces 78, which are separated from each other, increasing the stress against impact.

The impact parts 50 have upper and lower spaces formed by the bead groove 55 and the upper and lower spaces are closed by plates 100, 110, so that a plurality of such sealed spaces are formed in the impact parts, increasing strength of the impact parts 50.

Referring to FIG. 14 and FIG. 15, the central impact part 50 is extended to the tower parts 60 through a same section without a bead groove by roll forming, and the reinforcement plate 80 attached to the rear part of the impact part 50 is formed with the bead part 85 in the complementary shape with the connection parts 70 and the tower parts 60. Referring to FIG. 13, the upper closed sectional surfaces 77 and the lower closed sectional surfaces 78 are further extended to the position of the central impact part 50.

Therefore, the upper closed sectional surfaces 77 and the lower closed sectional surfaces 78 are extendedly formed from the impact part 50 to the tower parts 60 through the connection parts 70, so that the section modulus becomes increased entirely and stress against impact becomes increased accordingly.

Referring to FIG. 17, the graph shows a breakage curve of the bumper reinforcement for an automobile according to the present invention, from which it becomes apparent that the stress against impact becomes increased comparing with that of FIG. 16 which shows a graph of a breakage curve of a prior art.

Although the foregoing description has been made with reference to the preferred embodiments, it is to be understood that changes and modifications of the present invention may be made by the ordinary skilled in the art without departing from the spirit and scope of the present invention and appended claims.

1. A bumper reinforcement for an automobile, comprising:
an impact part positioned at a front part of a body frame of an automobile;
tower parts formed at both right and left ends of the impact part to be fixed to the body frame;
connection parts for connecting the tower parts to the impact part; and
a reinforcement plate having at least two or more upper closed surfaces and lower closed surfaces divisionally formed in the connection part.

2. The bumper reinforcement as claimed in claim 1, wherein a bead groove is formed from the impact part to the tower parts through the connection parts and folded backward, and the flat reinforcement plate is attached to rear surfaces of the connection parts, so that the upper closed surfaces and the lower closed surfaces are divisionally formed.

3. The bumper reinforcement as claimed in claim 1, wherein the bead groove is formed from the impact part to the tower parts through the connection parts, and a bead part is protruded from the reinforcement plate by a depth enough to contact the bead groove while the reinforcement plate is folded in the complementary shape with flange parts, so that the upper closed surfaces and the lower closed surfaces are divisionally formed.

4. The bumper reinforcement as claimed in claim 1, wherein a front plate closes the central impact, the connection parts and the tower parts, and the reinforcement plate is formed in the complementary shape with the flange parts and formed with the bead part protruded by a depth for contacting the closed front plate, so that the upper closed surfaces and the lower closed surfaces are divisionally formed.

5. The bumper reinforcement as claimed in claim 1, wherein the impact part is formed with flange parts at upper and lower parts thereof and the bead groove extended in the center to the tower parts through a same sectional surface, and the reinforcement plate attached to a rear part of the impact part is formed with the bead part in the center in the complementary shape with the connection parts and the tower parts, so that the upper closed surfaces and the lower closed surfaces are divisionally formed.
